(19) United States
(12) Patent Application Publication
(10) Pub. No.: US 2011/0249233 A1
(43) Pub. Date: Oct. 13, 2011

(54) Leather/suede nose bridge vaneer (known as SiWo shielder) for preventing indentions, inflammation, scars, marks and discoloration caused by the stem of eyeglasses, sunglasses, fashion eye wears, and 3-D glasses

(76) Inventor: Simin S. Wong, Rockville, MD (US)

(21) Appl. No.: 12/798,742

(22) Filed: Apr. 12, 2010

(51) Int. Cl. G02C 5/12

(52) U.S. Cl. 351/139

(57) ABSTRACT

All eyewear exert stress on the bridge of the nose of people who wear them, causing blood to be trapped under the surface of the skin of the nose bridge, and including indentation, inflammation, wrinkles and holes, making skin look prematurely aged. As a result, some people choose not to wear their eyewear “worrying” about deep pressure marks, indentation and holes. SiWo Shielder Nose Bridge Protective Veneer prevents indentations, and damages induced by wearing eyewear. Preliminary market testing indicates effective prevention of irritation caused by the weight, and rubbing of nose pads attached to the stems of eyewear on the skin of upper part of the nose making wearing eyewear feel 80 percent more comfortable and tolerable, allowing the wearer to put on their eyewear “three times” longer. SiWo Shielder is made of finest lightweight organic material, designed to be a neat and fashionable accessory.

This invention is a process and device for protecting the skin and tissue on nose bridge area to prevent indentions, inflammation, scars, spots, marks, and discoloration caused by the stem of eyeglasses or sunglasses or fashion eyewear, and also 3-D glasses. The skin and tissue covering the upper, bony part of the nose commonly known as the bridge of the nose, is extremely delicate and thin, and prone to dryness, wrinkle, and contusion. When wearing eye glasses, whether sun glasses to protect one's eyes from sun damage/ultraviolet rays, or reading/distance glasses, or fashion eyewear, or 3-D glasses to watch television, the weight of the glasses and the pressure from the stems exert extreme stress on the bridge of the nose. This stress compresses and indents the skin covering both side of the nose bridge. Over time, this part of the facial skin where the nose pads of sun or reading/distance glasses rest, will become irritated and inflamed and will be damaged. This injury includes indentation, dryness, discoloration and dark brownish red marks and bumps, i.e., contusion and bruises. These damages are caused by the weight of the glasses which continuously compresses the skin, and by rubbing of the nose pads of the glasses which are synthetic, usually made of urethane and bruise inducing the Leather/Suede Nose Bridge Veneer (known as SiWo Shielder), a designed and well-cut out and finished veneer/layer of soft leather/suede is worn under the eyewear to protect the nose bridge area of the wearer by way of fitting between the eyewear and the wearer's nose bridge area distributing the pressure and stress from the stem of eyewear.

### FIELD OF THE INVENTION

This invention relates generally to the field of prevention, dermatology and skin inflammation. In particular, the invention relates to the nose bridge and wearing of eyeglasses and eyewear used for reading, and sun protection, fashion eyewear and 3-D glasses worn to watch TV.

### BACKGROUND

The eyewear resting on the bridge of the nose can cause pressure marks and indentations and inflammation and bruising of the skin covering nose bridge area. Even the lightest eye glasses/eyewear and the softest nose pads attached to eyewear, continuously compress and suppress the skin covering the bridge of the nose. As a result of this skin suppression, small blood vessels of the skin of the upper, bony part of the nose are crushed, and marks and indentations start to appear where the blood is trapped under the surface of the skin on both sides of the nose bridge.

If not protected, sooner or later, wearing any kind of eyewear/glasses eventually brings about indentation and contusion on both sides of the nose bridge where nose pads rest which would not go away and leaves permanent indentations, and this would age and wrinkle and injure the skin. When this is unresolved, it can cause permanent damage to the skin. As a result, some people choose not to wear their eyewear.

The invention of the Leather/Suede Nose Bridge Veneer, a colorful, very soft well-designed and well-cut out and finished veneer/layer of soft leather/suede for nose bridge protection, prevents and significantly alleviates the problems related to pressure marks and indentations and inflammation and bruising of the skin caused by the stem of eyeglasses or sunglasses and fashion eyewear listed above and helps people to protect the skin covering their nose bridge area. A search of the prior inventions did not disclose any patents that read directly on the claims of the invention herein disclosed.

### OBJECTS AND ADVANTAGES

The Leather/Suede Nose Bridge Veneer described herein is unique and departs from any other possibilities in providing comfort, physically and mentally, and style to wearers of eyeglasses, sunglasses, and fashion eyewear, and 3-D glasses worn to watch TV.

This unique invention, The Leather/Suede Nose Bridge Veneer, a well-designed and well-cut out and finished layer of soft leather/suede for eyeglasses, sunglasses, fashion eyewear, and 3-D glasses worn to watch TV, discloses a leather/suede veneer which covers the nose bridge area. It includes a leather/suede veneer to prevent pressure marks and inflammation. This extremely soft leather/suede veneer protects the wearer's bridge of the nose from any irritation caused by wearing eyeglasses or sunglasses or fashion eyewear, or 3-D glasses worn to watch TV. The present invention prevents lasting indentions from forming on the nose bridge area and prevents bruising and scars on the nose bridge.

The present invention (The Leather/Suede Nose Bridge Veneer, a well-designed and well-cut out and finished layer of soft leather/suede for eyeglasses or sunglasses or fashion eyewear) discloses that protecting the nose bridge and preventing facial marks and sores allow the wearer to think about the making sure to wear their eyewear all the time without worrying about irritation and indentation on the skin of the nose bridge. Psychological benefit includes a more positive self image by preventing the skin covering the nose bridge from aging or looking aged. The present invention makes wearing eyewear fun by being colorful and very soft as well as personalized. It also allows individual style for each person by being available in many colors. The present invention can match other clothing, and feel more like an essential personal accessory.

The present invention (The Leather/Suede Nose Bridge Veneer, a well-designed and well-cut out and finished layer of soft leather/suede for eyeglasses or sunglasses or fashion eyewear, or 3-D glasses worn to watch TV.) is to be worn on the nose bridge under eye glasses, sun glasses, and fashion eyewear, or Three D Glasses. It covers and loops around the nose bridge, and effectively reduces the pressure of eyeglasses, sunglasses, and fashion eyewear on the nose bridge area of the wearer.

The present invention, the Leather/Suede Nose Bridge Veneer (SiWo Shielder) is constructed of natural/organic fabric material. While any fabric can be used, thin leather/suede is the right fabric because of its naturally soft and non-slippery surface and tendency to remain completely free from “raveling” when cut, so as to remain un-hemmed in the application.

The present invention is made of the finest, lightest, and softest genuine leather/suede and finished with a fine craftsmanship and can be changed often when the wearer wants a different color.

The present invention, the Leather/Suede Nose Bridge Veneer (SiWo Shielder) is designed in black, red, purple, blue, ivory, brown, and charcoal, and gold. The present invention is also designed in two tones: (a) black and red, and (b) purple and charcoal.

The present invention, the Leather/Suede Nose Bridge Veneer, is the most effective control to protect the nose bridge by preventing skin contusion and bruises. It is also designed to be symmetry, equilibrium between an indentation and contusion prevention measure and a good look. One can wear it not only as a defense system against skin damage and skin aging caused by eye glasses, sun glasses, and fashion eyewear but also as a fashion statement. The present invention also helps eye glasses/eyewear/3-D glasses stay in place.

### DESIGN AND STYLE

The Present Invention, SiWo Shielder, is a well-designed and well-cut out and finished veneer/layer of soft leather/suede of the type comprising a supple body of material having enough depth sufficient to provide protection to the skin of a human, a very unique concept/invention/design outcome wherein said veneer has a refined and tasteful shape, and an exclusively neat style, and size to maintain the delicate skin covering the nose bridge;

SiWo Shielder design includes a body of one or two layers of a soft leather/suede material, comprising at least one material having pile depth sufficient to provide cushion and comfort to the skin of persons wearing eyewear/reading glasses/sun glasses/fashion eyewear/3-D glasses worn to watch TV. SiWo Shielder makes it possible for a person to wear eyewear in comfort without damaging and causing lasting physical impressions on the skin of the nose bridge, with a unique and refined style, wherein said SiWo Shielder has a “pleasing to the eye” and neat design and size to provide protection and support for a nose bridge in good taste.

The present invention, the Leather/Suede Nose Bridge Veneer (SiWo Shielder) is constructed and designed and finished using natural/organic fabric material. While any fabric can be used, thin yet sufficiently thick leather/suede is the right fabric. That is because it is naturally soft and comfortable and has non-slippery surface when worn. It stays between the nose bridge part/eyewear stems and the skin of wearer. Leather/suede has also tendency to remain completely free from “raveling” when cut, so as to remain un-hemmed in the application.

The present invention are designed and finished to have rounded and comfortably soft edge around the periphery with sufficient thickness to be comfortable yet not bulky and inelegant. The present invention SiWo Shielder may be worn or removed easily as desired.

The present invention comes in two different designs:
A. Basic SiWo Shielder that can match clothing and feel very comfortable, and is more like a necessary personal accessory to be worn on the nose bridge under eye glasses, sun glasses, and fashion eyewear or e-D glasses worn to watch TV. It covers and loops around the nose bridge, and effectively reduces the pressure of eyeglasses, sunglasses, and fashion eyewear, and 3-D glasses worn to watch TV on the nose bridge area of the wearer, preventing physical impressions and indentation and bruising on the skin. The present invention also helps eye glasses/eyewear stay in place. It is made of the finest, lightest, and softest genuine leather/suede and finished with a fine craftsmanship and can be changed often when the wearer wants a different color. It fits any style of glasses. The basic versions comes in two sizes (see the document titled “Replacement Drawings”):

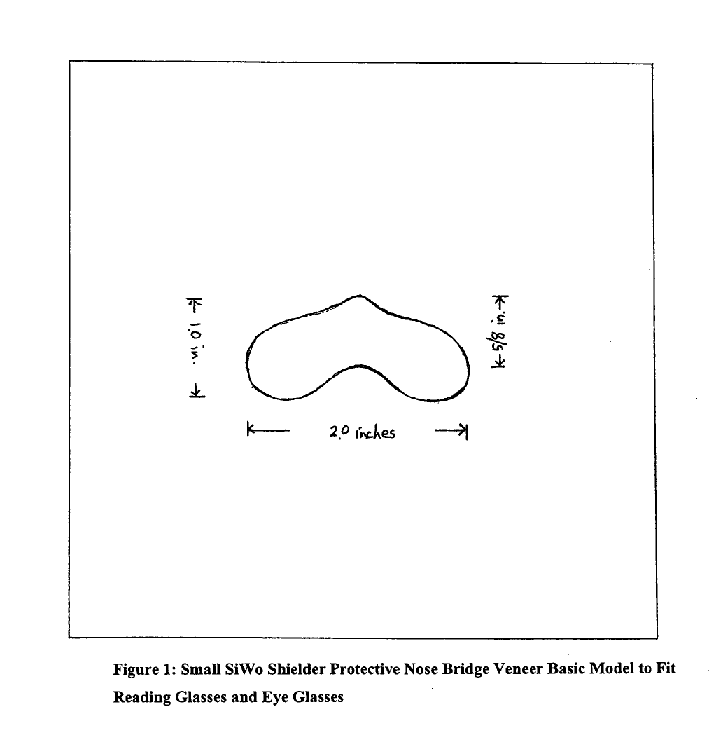

FIG. 1 shows small SiWo Shielder Protective Nose Bridge Veneer basic model to fit reading glasses and eye glasses with dimension (2.0 inch by 1.0 inch).

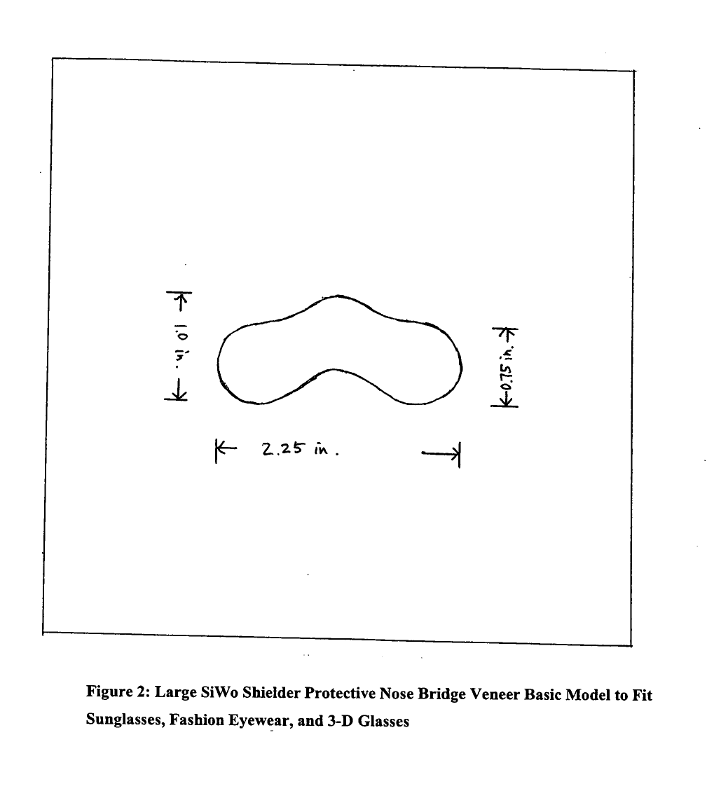

FIG. 2 shows large SiWo Shielder Protective Nose Bridge Veneer basic model to fit sunglasses and fashion eyewear, and 3-D glasses with dimension (2.25 inch by 1.0 inch).
B. Limited Edition Decorative SiWo Shielder is elaborate and lavish in design. This group of SiWo Shielder is patterned in “six” different attractive and striking styles which are hand painted (see the document titled “Replacement Drawings”):

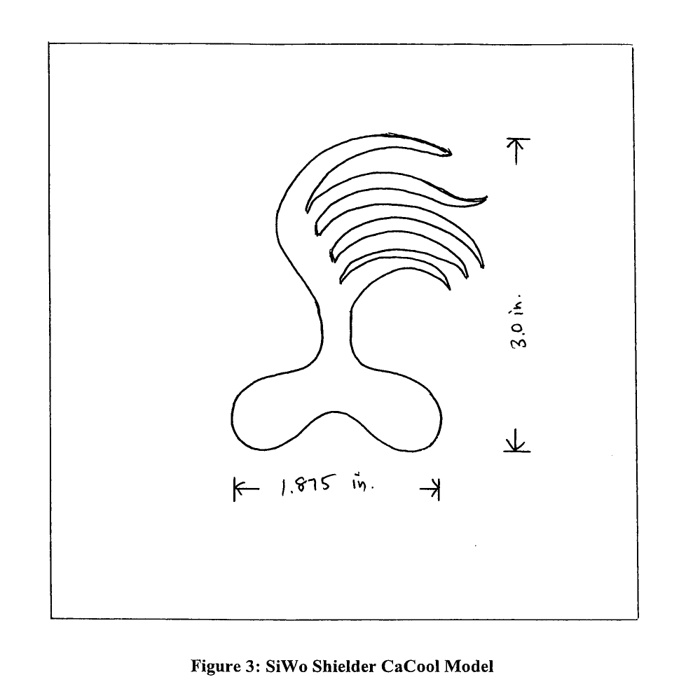

FIG. 3 shows SiWo Shielder CaCool model.

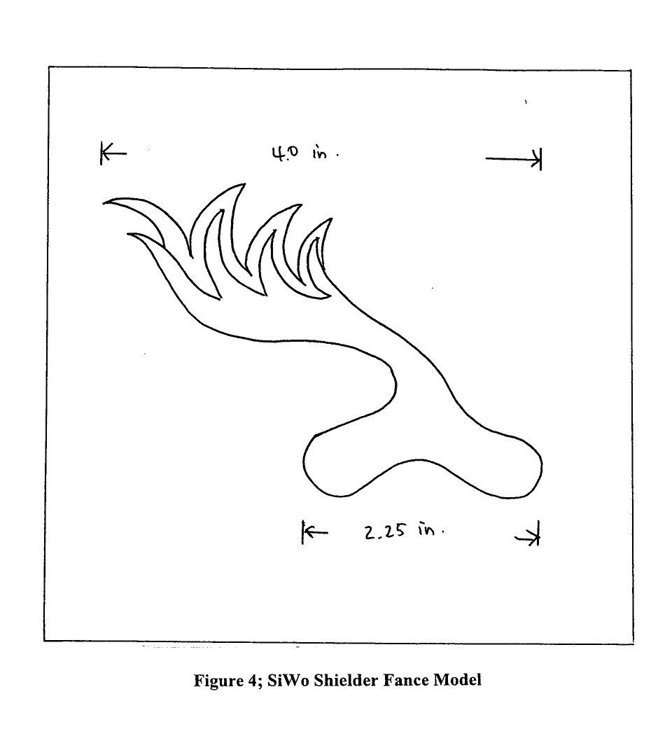

FIG. 4 shows SiWo Shielder Fance model.

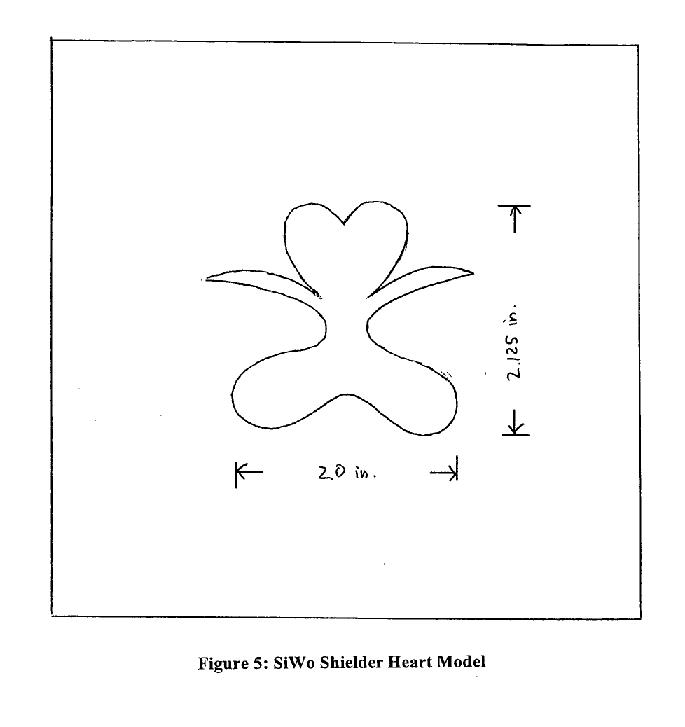

FIG. 5 shows SiWo Shielder Heart model.

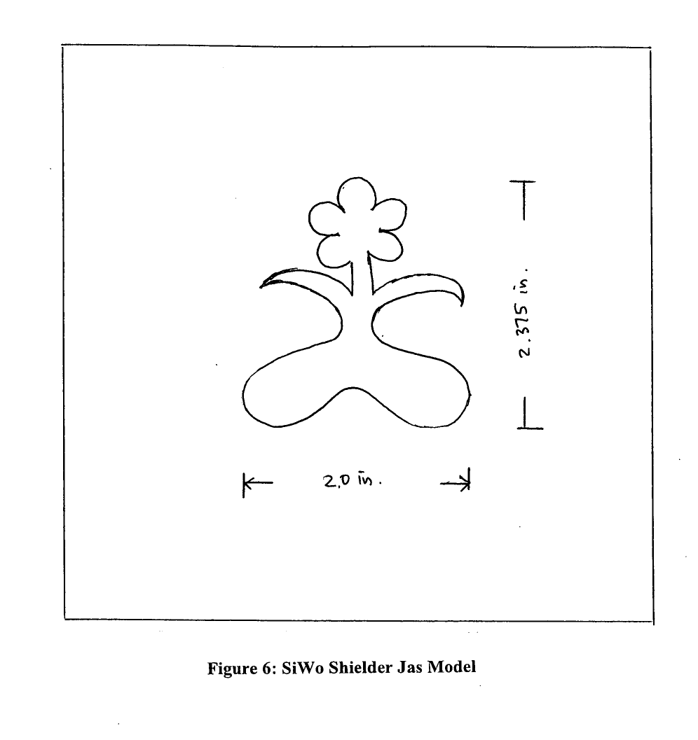

FIG. 6 shows SiWo Shielder Jas model.

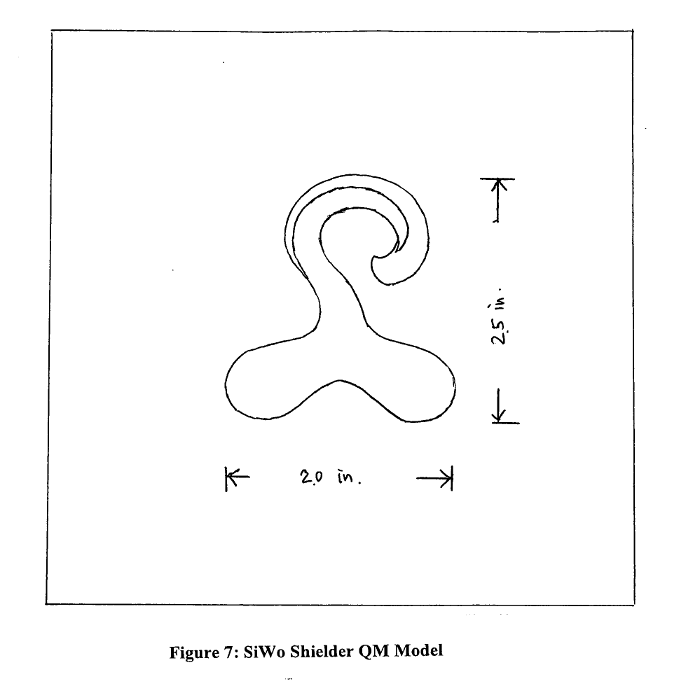

FIG. 7 shows SiWo Shielder QM model.

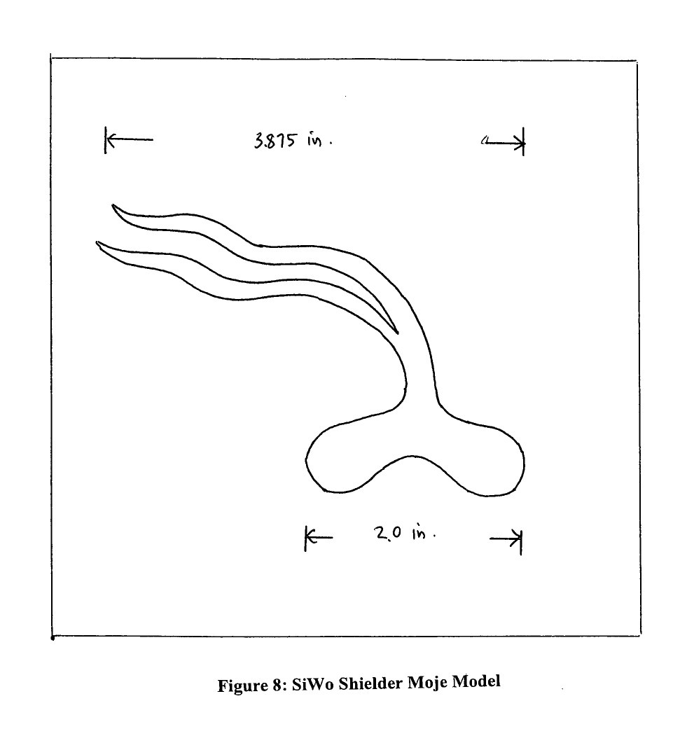

FIG. 8 shows SiWo Shielder Moje model.

Limited Edition Decorative SiWo Shielder is fun and amusing to oneself to wear, and engaging for others to look at. It is placed on an appropriated location on the nose bridge between the eyewear pads attached to the stems.

### SUMMARY

In accordance with the present invention, The Leather/Suede Nose Bridge Veneer, a well-designed and well-cut out and finished layer of soft leather/suede for eyeglasses or sunglasses or fashion eyewear and Three D Glasses worn to watch TV, comprises a durable, suitably thick-enough leather/suede designed and formed in a fashion that provides a preventive layer to protect the skin on the nose bridge of a wearer of eye glasses, sun glasses, and fashion eyewear, and Three D Glasses worn to watch TV. This The Leather/Suede Nose Bridge Veneer invention prevents the skin and tissue covering the nose bridge from injuries caused when the capillaries are damaged due to continuous compressing and rubbing on the skin by the weight of eyewear and nose pads attached to the stems of eyewear, allowing the blood to seep into the surrounding tissue bringing about discoloration, indentation, bumps and bruises. The present invention is made of lightweight and soft leather/Suede material shaped and designed to simply covers and loops around the nose bridge to protect the skin and tissue on the both side of the bridge of the nose.

It can be worn under all eyewear including reading/distance and prescription glasses and sun glasses and fashion eyewear, and Three D Glasses worn to watch TV to prevent injury to the skin covering the nose bridge. It is to be worn before putting on an eye wear.

This invention increases comfort, prevents indentations, redness and inflammation, and discoloration and bruising on the nose bridge for people wearing eyewear which ultimately results in protecting and keeping the skin on the nose bridge healthy. The present invention also helps eye glasses/eyewear stay in place.

1. A well-designed and well-cut out and finished veneer/layer of soft leather/suede of the type comprising a supple body of material having enough depth sufficient to provide protection to the skin of a human, a very unique concept/invention/design outcome wherein said veneer has a refined and tasteful shape, and an exclusively neat style, and size to maintain the delicate skin covering the nose bridge/preventive utility: (a) consisting of at least one layer of material, (b) a dimension of approximate size to surround said nose bridge part where the eyewear sits and extending beyond a predetermined length around the nose bridge part, and (c) a location along said layer whereby a human wearing said eyewear can do so in comfort without damaging and causing lasting physical impressions.

2. A designed and well-cut out and finished veneer/layer of soft leather/suede of claim 1 wherein said material comprises leather, suede and weights whereby a sufficient thickness can be maintained between the nose bridge part/eyewear's stems and the skin of wearer.

3. A designed and well-cut out and finished veneer/layer of soft leather/suede of claim 1 wherein said material may be colorful and of such design whereby wearer can express personal style.

4. A designed and well-cut out and finished veneer/layer of soft leather/suede of claim 1 wherein said material is sufficiently supple to be folded against itself to form the shape comprising a form to fit over the nose bridge interface.

5. A designed and well-cut out and finished veneer/layer of soft leather/suede in claim 1 whereas said material layer or layers s are held together in close along both lateral edges.

6. A designed and well-cut out and finished veneer/layer of soft leather/suede comprising a body of one or two layers of a soft leather/suede material comprising at least one material having pile depth sufficient to provide cushion to the skin with a unique and refined shape, wherein said layer has a “pleasing to the eye” and neat style and size to provide protection and support for a nose bridge support in good taste.

7. The designed and well-cut out and finished veneer/layer of soft leather/suede of claim 6 wherein the layer or layers of said supple decorative leather and suede material are secured together to form more depth.

8. The designed and well-cut out and finished veneer/layer of soft leather/suede of claim 6 comprising at least one or more layers of padding wherein the inner layer of supple material lays flat within the visible portion of said supple decorative leather/suede material.

9. The designed and well-cut out and finished veneer/layer of soft leather/suede of claim 6 comprising an outermost layer having decorative as well as functional purpose.

10. A designed and well-cut out and finished veneer/layer of soft leather/suede comprising a material of predetermined length and material to protect the skin of nose bridge from by preventing indentions, scar, spot, mark and discoloration, and permanent damage caused by the pressure exerted by eyewear.

11. The designed and well-cut out and finished veneer/layer of soft leather/suede of claim 10 having the extension of such material that is of sufficient thickness and density as to distribute the pressure across the wearer's nose bridge area.

12. The designed and well-cut out and finished veneer/layer of soft leather/suede of claim 10 wherein the outermost layer comprising material having decorative as well as functional purpose.
